(19) United States
(12) Patent Application Publication
(10) Pub. No.: US 2026/0346871 A1
(43) Pub. Date: Nov. 5, 2026

(54) SAFETY PLANNING SYSTEM FOR AUTONOMOUS DRIVING VEHICLE AND SAFETY PLANNING METHOD THEREFOR

(71) Applicant: TSINGHUA UNIVERSITY, BEIJING (CN)

(72) Inventors: JUNZHI ZHANG, BEIJING (CN); JUNFENG ZHANG, BEIJING (CN); CHENGKUN HE, BEIJING (CN); RUIHAI MA, BEIJING (CN)

(21) Appl. No.: 19/486,957

(22) PCT Filed: Jun. 30, 2023
(86) PCT No.: PCT/CN2023/104904

§ 371 Date: Nov. 24, 2025

(30) Foreign Application Priority Data
May 26, 2023 (CN) 202310610864.4

(51) Int. Cl. B60W 60/00

(52) U.S. Cl. CPC B60W 60/0015; B60W 60/0027; B60W 2420/403; B60W 2420/408

(57) ABSTRACT

A safety planning system for an autonomous driving vehicle (ADV) includes: a plurality of types of sensors configured to collect a plurality of sensor signals of the ADV; an autonomous driving domain controller that generates a trajectory signal and a wheel-speed signal according to a dynamics safety margin signal and a planning decision-making signal; and a chassis domain controller that generates a control signal for a vehicle-related system by performing control allocation based on a vehicle estimation and prediction signal and a motion control signal, and sends the control signal to a corresponding actuator.

### CROSS-REFERENCE TO RELATED PATENT APPLICATION

This application is the U.S. National Stage Application of International Application No. PCT/CN2023/104904, filed on Jun. 30, 2023, which is based on and claims priority to Chinese Patent Application No. 2023106108644, filed on May 26, 2023, the entire contents of which are incorporated herein by reference.

### FIELD OF THE DISCLOSURE

The present disclosure relates to a field of automotive technology, and in particular to a system and a method for safety planning of an autonomous driving vehicle (ADV).

### BACKGROUND OF THE DISCLOSURE

With the development of intelligent and electrified autonomous driving vehicles (ADVs), a higher control priority for chassis of ADVs is needed to fully leverage the advantages of vehicle domain control and intelligent decision-making during autonomous driving, and improve the safety of ADVs.

At present, when an ADV enters extreme dynamics conditions such as low-adhesion roads and high-speed skid, the vehicle is completely taken over by extreme dynamics controllers such as controllers for an anti-lock braking system (ABS), electronic stability control (ESC), and a traction control system (TCS). The autonomous driving controller loses control of the vehicle until the above active safety controllers exit. This sudden intervention of the active safety controllers causes that the autonomous driving domain controller is temporarily unable to fully control dynamics of the whole vehicle, which is prone to unexpected safety accidents. At the same time, the active safety control has failed to fully utilize more perception information and high computing power during the autonomous driving to enhance its potential.

### SUMMARY OF THE DISCLOSURE

In a first aspect, the present disclosure provides a system for safety planning of an ADV. The system includes a plurality of types of sensors, an autonomous driving domain controller, and a chassis domain controller.

The plurality of types of sensors are configured to collect a plurality of sensor signals of the ADV.

The autonomous driving domain controller is configured to: obtain vehicle-related information by performing fusion calculation based on the plurality of sensor signals; obtain a dynamics safety margin signal by calculating the vehicle-related information; obtain a planning decision signal based on the dynamics safety margin signal; and generate a trajectory signal and a wheel speed signal based on the planning decision signal and the dynamics safety margin signal.

The chassis domain controller is configured to obtain a vehicle estimation and prediction signal by calculating the plurality of sensor signals and a dynamics control signal of the ADV. A trajectory/wheel speed tracking controller included in the chassis domain controller generates a motion control signal by performing coordinated control based on the trajectory signal, the wheel speed signal, and the vehicle estimation and prediction signal. A chassis dynamics controller included in the chassis domain controller generates a first control signal for a vehicle-related system by performing control allocation based on the vehicle estimation and prediction signal and the motion control signal, and sends the first control signal to a corresponding actuator.

In a second aspect, the present disclosure provides a method for safety planning in a system for safety planning of an ADV according to the first aspect. The method includes: obtaining, by the autonomous driving domain controller, a dynamics safety margin signal by calculating vehicle-related information, in which the vehicle-related information is obtained by performing fusion based on a plurality of sensor signals; generating, by the autonomous driving domain controller, a trajectory signal and a wheel speed signal based on the dynamics safety margin signal and a planning decision signal, in which the planning decision signal is obtained based on the dynamics safety margin signal; obtaining, by the chassis domain controller, a vehicle estimation and prediction signal by performing calculation based on the plurality of sensor signals and a dynamics control signal of the ADV; and generating, by the chassis domain controller, a motion control signal by performing coordinated control based on the trajectory signal, the wheel speed signal, and the vehicle estimation and prediction signal, and obtaining, by the chassis domain controller, a control signal for a vehicle-related system by performing control allocation based on the vehicle estimation and prediction signal and the motion control signal.

In a third aspect, the present disclosure provides a non-transitory computer-readable storage medium having stored a computer program which, when executed by a processor, implements a method for safety planning in a system for safety planning of the ADV in the second aspect.

### BRIEF DESCRIPTION OF THE DRAWINGS

The above and/or additional aspects and advantages of the present disclosure will become obvious and easy to understand from the following description of the embodiments in conjunction with the accompanying drawings.

FIG. 1 is a schematic diagram illustrating a system for safety planning of an ADV according to an embodiment of the disclosure.

FIG. 2 is a flowchart illustrating a method for safety planning in a system for safety planning of an ADV according to an embodiment of the disclosure.

FIG. 3 is a flowchart illustrating another method for safety planning in a system for safety planning of an ADV according to an embodiment of the disclosure.

FIG. 4 is a diagram illustrating a computer device according to an embodiment of the disclosure.

### DETAILED DESCRIPTION OF THE EXEMPLARY EMBODIMENTS

Embodiments of the present disclosure are described in detail below, examples of which are shown in the accompanying drawings, throughout which the same or similar reference numerals represent the same or similar elements or elements having the same or similar functions. The embodiments described below with reference to the accompanying drawings are exemplary and are intended to explain the present disclosure but should not be construed as limiting the present disclosure.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another. A unit or module may be implemented purely by software, purely by hardware, or by a combination of hardware and software. In a pure software implementation, for example, the unit or module may include functionally related code blocks or software components, that are directly or indirectly linked together, so as to perform a particular function.

The present disclosure is to propose a system for safety planning of an autonomous driving vehicle (ADV). An active safety control function is integrated into path planning and control of the ADV. Dynamics margins of the ADV are calculated based on fusion perception information during a path planning process and safety restrictions are imposed on a path. A wheel speed control command is generated along with the path to ensure that the generated trajectory does not trigger safety functions such as an anti-lock braking system (ABS) during a chassis path tracking control and dynamics control process. The perception and decision-making capabilities of the autonomous driving part are fully utilized to improve the safety performance of the autonomous driving domain controller.

The following describes a system and a method for safety planning of an ADV, a device, and a storage medium according to the embodiments of the present disclosure with reference to the accompanying drawings.

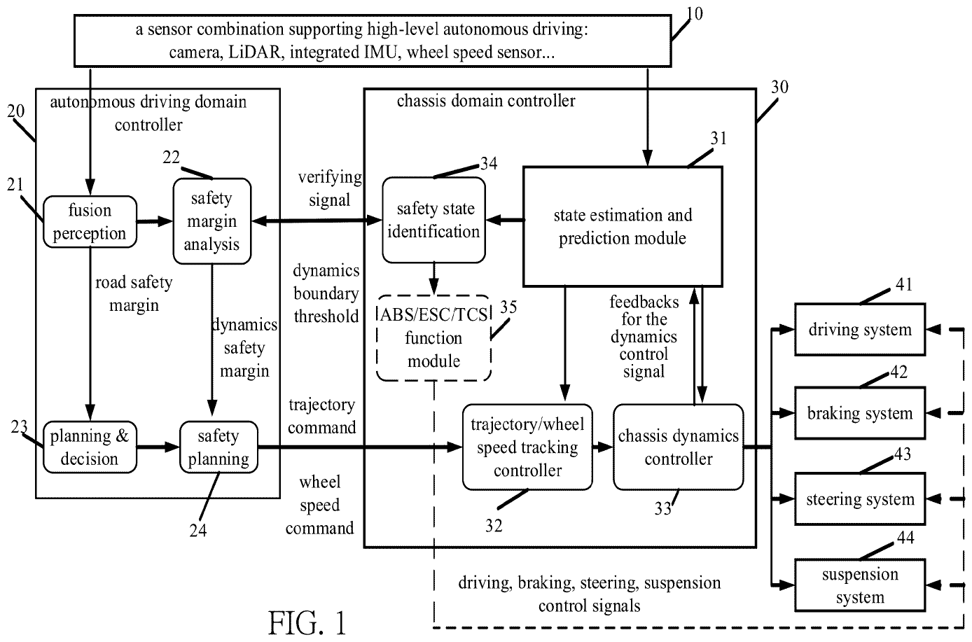

FIG. 1 is a schematic diagram illustrating a system for safety planning of an ADV according to an embodiment of the disclosure.

As shown in FIG. 1, The system includes a plurality of types of sensors 10, an autonomous driving domain controller 20, and a chassis domain controller The plurality of types of sensors 10 (i.e., a sensor combination supporting high-level autonomous driving) is configured to collect a plurality of sensor signals of the ADV.

The autonomous driving domain controller 20 includes a fusion perception module, a safety margin analysis module, a planning and decision module, and a safety planning module. The fusion perception module outputs vehicle-related information by fusing and calculating the plurality of sensor signals. The safety margin analysis module outputs a dynamics safety margin signal by calculating the vehicle-related information. The planning and decision module outputs a planning decision signal based on the dynamics safety margin signal. The safety planning module generates and outputs a trajectory signal and a wheel speed signal based on the planning decision signal and the dynamics safety margin signal.

The chassis domain controller 30 includes a state estimation and prediction module, a trajectory/wheel speed tracking controller, and a chassis dynamics controller. The state estimation and prediction module output a vehicle estimation and prediction signal by solving the plurality of sensor signals and a dynamics control signal of the whole vehicle. The trajectory/wheel speed tracking controller generates a motion control signal by performing coordinated control based on the trajectory signal, the wheel speed signal, and the vehicle estimation and prediction signal. The chassis dynamics controller generates a first control signal for a vehicle-related system by performing control allocation based on the vehicle estimation and prediction signal and the motion control signal, and sends the first control signal to a corresponding actuator.

It may be understood that there are a plurality of types of sensors 10 (i.e., a sensor combination supporting high-level autonomous driving), including a laser radar (LIDAR), a camera, an integrated inertial measurement unit (IMU) for autonomous driving sensing, and a wheel speed sensor in the chassis domain.

In an embodiment of the present disclosure, the autonomous driving domain controller 20 includes a fusion perception module 21, a safety margin analysis module 22, a planning and decision module 23, and a safety planning module 24.

The fusion perception module 21 receives a plurality of sensor signals of the ADV, and obtains obstacle information, road information, a vehicle position, and a speed signal through fusion calculation. At the same time, the fusion perception module 21 sends a road safety margin signal including the obstacle information and the road information to the safety margin analysis module 22 and the planning and decision module 23. The plurality of types of sensor signals include a LiDAR signal, a camera signal, an integrated IMU signal for autonomous driving sensing, and a wheel speed signal in the chassis domain.

The safety margin analysis module 22 obtains a dynamics safety margin signal, by calculating a road adhesion signal, an attitude signal, and a speed signal calculated by the fusion perception module 21 based on a dynamics model of the whole vehicle and a tire model. The dynamics safety margin signal includes a yaw rate limit and a slip rate limit. The safety margin analysis module 22 sends the safety margin signal to the safety planning module 24 and a safety state identification module 34 of the chassis domain controller 30.

The planning and decision module 23 makes intelligent decisions for autonomous driving based on the received safety margin information, including decisions on lane changing, straight driving, and obstacle avoidance, and sends a decision signal to the safety planning module 24.

The safety planning module 24 obtains an optimized trajectory signal constrained by the dynamics safety margin by calculating based on the received planning decision signal and dynamics safety margin information, when a dynamics state of the whole vehicle does not exceed the dynamics safety margin, and generates a wheel speed command along with a path to ensure that the generated trajectory is within the safety dynamics margin of the vehicle during execution. At the same time, the safety planning module 24 sends the trajectory signal and the wheel speed signal to the chassis domain controller 30. An optimization method (such as model prediction control) or an intelligent learning method (such as reinforcement learning) may be used for commands of the trajectory signal and the wheel speed signal. It is ensured that the generated trajectory signal needs to meet a road margin limit, the yaw rate limit, an acceleration limit, and a lateral acceleration limit, and the generated wheel speed signal needs to meet the slip rate limit to ensure the planned path and wheel speed of the whole vehicle meet dynamics safety requirements.

In an embodiment of the present disclosure, the chassis domain controller 30 includes a state estimation and prediction module 31, a trajectory/wheel speed tracking controller 32, a chassis dynamics controller 33, a safety state identification module 34 and an ABS/ESC/TCS function module 35.

The state estimation and prediction module 31 mainly calculates a current vehicle body dynamics state, obtains a position, a speed, an attitude of the whole vehicle, and a tire force signal by calculating the plurality of autonomous driving sensor signals and a dynamics control signal of the whole vehicle through the dynamics model of the whole vehicle, and sends them to the safety state identification module 34, the chassis dynamics control module 33, and the trajectory/wheel speed tracking control module 32. The sensor signals include the integrated IMU signal and the wheel speed signal. The dynamics control signal of the whole vehicle includes feedback signals from a driving system, a braking system, a steering system, and a suspension system.

The trajectory/wheel speed tracking controller 32 receives the trajectory signal and the wheel speed signal from the safety planning module 24, and the estimation and prediction signal from the state estimation and prediction module 31, performs longitudinal-lateral-vertical coordinated control on the chassis dynamics motion state, generates longitudinal and lateral motion control commands for a tracking trajectory and a wheel speed, including a lateral force, a longitudinal force and yaw moment commands, and sends them to the chassis dynamics controller 33.

The chassis dynamics controller 33 receives the motion control commands generated by the trajectory/wheel speed tracking controller 32, and the estimation and prediction signal from the state estimation and prediction module 31. For the received motion control commands and the estimation and prediction signal, the chassis dynamics controller 33 performs allocation calculation for wire-controlled actuators according to an algorithm of vehicle dynamics control, so as to generate control signals for the driving system 41, the braking system 42, the steering system 43 and the suspension system 44 of the vehicle. The control signals are sent to the corresponding actuators.

The safety state identification module 34 receives the dynamics safety margin signal calculated by the safety margin analysis module 22, and the current vehicle body dynamics state estimated by the state estimation and prediction module 31, and performs verification with regard to selected physical quantities related to vehicle body stability, such as a wheel speed, a yaw rate, and a lateral acceleration. When the physical quantities are within a dynamics safety margin threshold, safety planning and dynamics control will continue to be performed according to the safety planning method for the autonomous driving domain control. When the physical quantities exceed the dynamics safety margin threshold, it means that the motion state of the whole vehicle is in a critical state and the current planned path and wheel speed can no longer be guaranteed, and the vehicle body stability needs to be a main control goal. In this case, the ABS/ESC/TCS function module 35 will be activated, and a verification failure signal will be sent to the autonomous driving domain controller 20. The autonomous driving domain controller 20 will temporarily give up the vehicle body control, until the vehicle body state returns to be within the safety margin.

When the dynamics state of the whole vehicle exceeds the dynamics safety margin limit, the ABS/ESC/TCS function module 35 is activated to temporarily take over the dynamics control of the whole vehicle, generates control signals for the driving system 41, the braking system 42, the steering system 43 and the suspension system 44 of the whole vehicle, and sends them to the corresponding actuators. The ABS/ESC/TCS function module 35 exits after controlling the vehicle state to be within the safety margin.

Through the system for safety planning of an ADV in the embodiments of the present disclosure, active safety control functions are integrated into the vehicle path planning control. During the path planning process, the dynamics margins of the vehicle are calculated based on the fusion perception information and safety restrictions are imposed on a path. A wheel speed control command is generated along with the path to ensure that the generated trajectory does not trigger safety functions such as ABS during a chassis path tracking control and dynamics control processes, thereby fully utilizing the perception and decision-making capabilities of the autonomous driving part to improve the safety performance of the autonomous driving domain controller.

Next, a method for safety planning in a system for safety planning of an ADV proposed according to an embodiment of the present disclosure may be described with reference to the accompanying drawings.

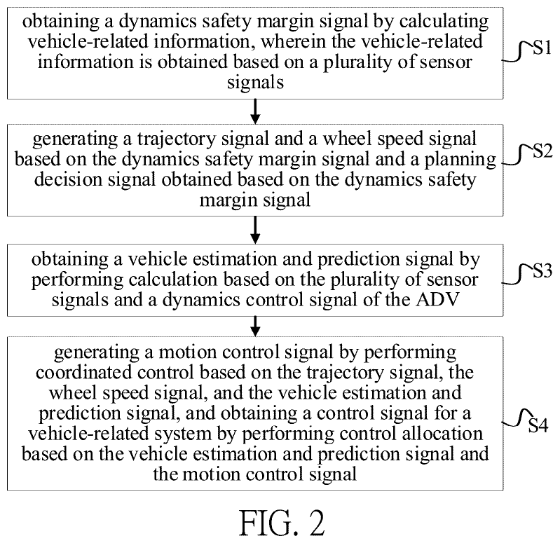

FIG. 2 is a flowchart illustrating a method for safety planning in a system for safety planning of an ADV according to an embodiment of the disclosure.

As shown in FIG. 2, the method includes the following steps S1 to S4.
At S1, a dynamics safety margin signal is obtained by calculating vehicle-related information that is obtained based on a plurality of sensor signals.
At S2, a trajectory signal and a wheel speed signal are generated based on the dynamics safety margin signal and a planning decision signal obtained based on the dynamics safety margin signal.
At S3, a vehicle estimation and prediction signal is obtained by performing calculation based on a plurality of sensor signals and a dynamics control signal of the ADV.
At S4, a motion control signal is generated by performing coordinated control based on the trajectory signal, the wheel speed signal, and the vehicle estimation and prediction signal, and a control signal for a vehicle-related system is obtained by performing control allocation based on the vehicle estimation and prediction signal and the motion control signal.

It may be understood that the existing safety control scheme for the ADV mainly relies on the chassis dynamics controller to track the path calculated by the autonomous driving controller. When safety risks occur in emergency conditions such as low adhesion and sudden braking, safety functions such as ABS/ESC/TCS will be directly triggered. However, this existing solution makes emergency conditions more likely to be triggered, and the autonomous driving domain controller is temporarily unable to fully control the dynamics of the whole vehicle, which may easily lead to unexpected safety accidents. To this end, the present disclosure makes full use of more perception information and high computing power during the autonomous driving to enhance its safety potential, reduces triggering of safety functions such as ABS/ESC/TCS, and improves the safety performance of the vehicle.

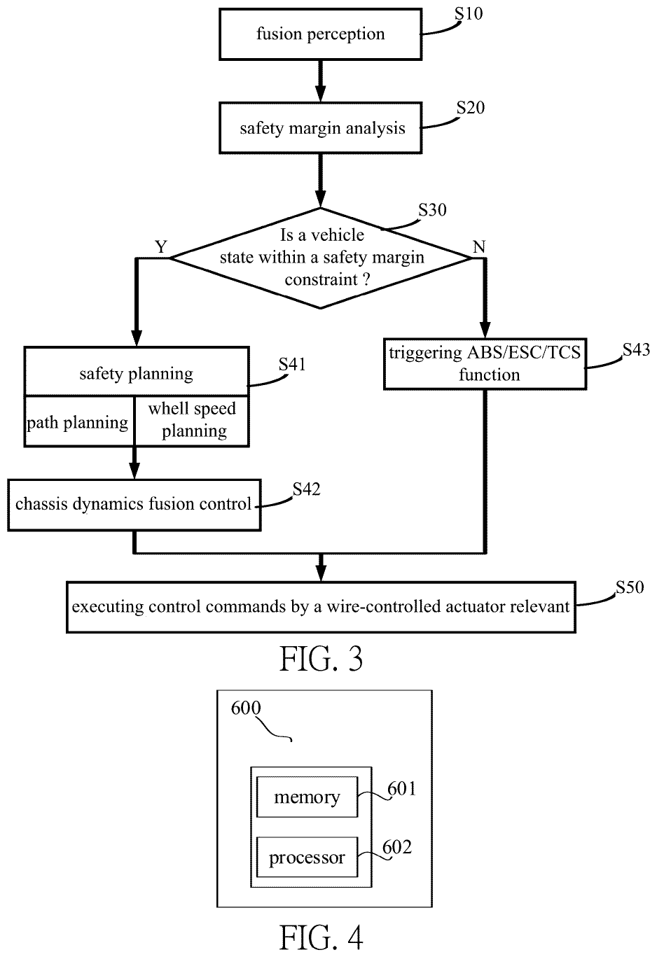

In an embodiment of the present disclosure, FIG. 3 is a logic diagram of a method for safety planning in a system for safety planning of an ADV according to an embodiment of the present disclosure.

Fusion perception S10 is used to receive signals from a plurality of sensors during autonomous driving and obtain obstacle information, road adhesion information, a position, an attitude and a speed signal of the vehicle via fusion calculation.

Safety margin analysis S20 is used to obtain the dynamics safety margin signal by calculating a road adhesion signal, an attitude signal, and a speed signal obtained via fusion perception based on a dynamics model and a tire model of the vehicle, in which the dynamics safety margin signal includes a yaw rate limit and a slip rate limit in this state.

Safety state identification S30 is used to identify and estimate a vehicle state estimation and prediction signal and receives safety margin information from the safety margin analysis module to determine whether a vehicle dynamics state is within a safety margin state limit.

When the vehicle dynamics state does not exceed the dynamics safety margin limit, state safety planning at S41 is performed. Based on the received planning decision signal and dynamics safety margin information, an optimized trajectory signal constrained by the dynamics safety margin limit is calculated, and a wheel speed command is generated along with a path to ensure that a generated trajectory is within the vehicle safety dynamics margin limit during execution. At the same time, chassis dynamics fusion control at S42 is performed to calculate and allocate control commands for wire-controlled actuators. Finally, step S50 is performed, and the chassis wire-controlled actuator executes relevant control commands, including driving and braking force commands of each wheel, a steering angle command of the steering system, an active force command of an active suspension system, etc.

When the vehicle dynamics state exceeds the dynamics safety margin limit, the ABS/ESC/TCS function at S43 is directly triggered to temporarily take over dynamics control of the whole vehicle. As such, a traditional ABS/ESC/TCS safety algorithm quickly restores the vehicle stability and improves an adhesion utilization rate of the vehicle. Finally, step S50 is performed, and the chassis wire-controlled actuator executes relevant control commands, including driving and braking force commands of each wheel, a steering angle command of the steering system, an active force command of an active suspension system, etc.

To sum up, with the rise of intelligent automobiles, the intelligent automobiles have gradually improved their computing power and perception capabilities, increased their safety requirements, and deepened collaborative interaction between the chassis domain and the autonomous driving domain. This disclosure utilizes perception information and planning capabilities during the autonomous driving while ensuring the safety, reduces the triggering of risk scenarios, improves the safety of ADVs, and has broad application prospects.

According to the embodiments of the present disclosure, the method for safety planning in a system for safety planning of an ADV is proposed. The chassis domain controller for safety planning of the ADV in the present disclosure may fully utilize the perception and computing capabilities of the ADV, reduce unexpected triggering of functions such as ABS/TCS/ESC, improve the vehicle body stability of the ADV during driving, and keep active safety capabilities under emergency conditions.

In order to implement the method in the above embodiments, the embodiment of the present disclosure further provides a computer device. As shown in FIG. 4, the computer device 600 includes a memory 601 storing executable program codes and a processor 602. When the executable program codes are read and a program corresponding to the executable program codes is executed by the processor 602, various steps of the method for safety planning in the system for safety planning of the ADV is implemented.

In order to implement the above embodiments, the embodiment of the present disclosure further provides a non-transitory computer-readable storage medium on which a computer program is stored. When the computer program is executed by a processor, the method for safety planning in the system for safety planning of the ADV as described in the above embodiments is implemented.

In order to implement the above embodiments, the embodiment of the present disclosure further provides a computer program product including a computer program. When the computer program is executed by a processor, the method for safety planning as described in the above embodiments is implemented.

In order to implement the above embodiments, the embodiment of the present disclosure further provides a computer program, which includes computer program codes. When the computer program codes are running on a computer, the computer is caused to perform the method for safety planning described in the above method embodiments.

It should be noted that the aforementioned explanations in the embodiments of the method for safety planning are also applicable to the non-transitory computer-readable storage medium, the computer program product, and the computer program in the embodiments of the present disclosure, which will not be repeated here.

In addition, the terms “first” and “second” are used for descriptive purposes only and should not be understood as indicating or implying relative importance or implicitly indicating the quantity of the indicated technical features. Therefore, features defined as “first” or “second” may explicitly or implicitly include at least one of the features. In the description of the present disclosure, “a plurality of” means at least two, for example, two, three, etc., unless otherwise clearly and specifically defined.

In the description of this specification, reference to the terms “an embodiment”, “some embodiments”, “example”, “specific example”, or “some examples” means that the specific features, structures, materials or characteristics described in conjunction with the embodiment or example are included in at least one embodiment or example of the present disclosure. In this specification, the schematic expressions of the above terms do not necessarily refer to the same embodiment or example. Furthermore, the specific features, structures, materials, or characteristics described may be combined in any suitable manner in any one or more embodiments or examples. Furthermore, those skilled in the art may integrate and combine different embodiments or examples and features of different embodiments or examples described in this specification without mutual contradiction.

Although the embodiments of the present disclosure have been shown and described above, it may be understood that the above embodiments are for example and are not to be construed as limitations on the present disclosure. A person skilled in the art may change, modify, replace and vary the above embodiments within the scope of the present disclosure.

1. A system for safety planning of an autonomous driving vehicle (ADV), comprising: a plurality of types of sensors, configured to collect a plurality of sensor signals of the ADV; an autonomous driving domain controller; and a chassis domain controller;
wherein the autonomous driving domain controller is configured to:
obtain vehicle-related information by performing fusion calculation based on the plurality of sensor signals,
obtain a dynamics safety margin signal by calculating the vehicle-related information,
obtain a planning decision signal based on the dynamics safety margin signal, and
generate a trajectory signal and a wheel speed signal based on the planning decision signal and the dynamics safety margin signal; and
wherein the chassis domain controller comprises a trajectory/wheel speed tracking controller and a chassis dynamics controller;
the chassis domain controller is configured to obtain a vehicle estimation and prediction signal by performing calculation based on the plurality of sensor signals and a dynamics control signal of the ADV,
the trajectory/wheel speed tracking controller is configured to generate a motion control signal by performing coordinated control based on the trajectory signal, the wheel speed signal, and the vehicle estimation and prediction signal, and
the chassis dynamics controller is configured to generate a first control signal for a vehicle-related system by performing control allocation based on the vehicle estimation and prediction signal and the motion control signal, and send the first control signal to a corresponding actuator.

2. The system according to claim 1, wherein the chassis domain controller is further configured to:
determine whether a vehicle-related physical quantity meets a dynamics safety margin constraint condition by verifying the vehicle-related physical quantity based on the dynamics safety margin signal;
activate an anti-lock braking system (ABS)/electronic stability control (ESC)/traction control system (TCS) function and send a verification failure signal to the autonomous driving domain controller, in a case that the vehicle-related physical quantity does not meet the dynamics safety margin constraint condition; and
perform dynamics control of the ADV after activating the ABS/ESC/TCS, generate a second control signal for the vehicle-related system and send the second control signal to the corresponding actuator.

3. The system according to claim 2, wherein the autonomous driving domain controller is further configured to obtain a dynamics safety margin signal by calculating the vehicle-related information based on a dynamics model and a tire model of the ADV.

4. The system according to claim 1, wherein the autonomous driving domain controller is further configured to obtain a trajectory signal and a wheel speed signal by calculating the planning decision signal and the dynamics safety margin signal, in a case that a current vehicle dynamics state meets a dynamics safety margin constraint condition.

5. The system according to claim 4, wherein the autonomous driving domain controller is further configured to estimate the current vehicle dynamics state by identifying the vehicle estimation and prediction signal, and determine whether the current vehicle dynamics state meets the dynamics safety margin constraint condition based on the dynamics safety margin signal.

6. The system according to claim 1, wherein
the vehicle-related system comprises a driving system, a braking system, a steering system, and a suspension system of the ADV;
the planning decision signal comprises a lane changing decision signal, a straight driving decision signal, and an obstacle avoidance decision signal;
the dynamics safety margin signal comprises a yaw rate limit and a slip rate limit;
the trajectory signal meets a road margin limit, the yaw rate limit, an acceleration limit, and a lateral acceleration limit;
the wheel speed signal meets the slip rate limit; and
the dynamics control signal comprises feedback signals from the driving system, the braking system, the steering system, and the suspension system.

7. The system according to claim 1, wherein
the vehicle-related information comprises two or more of obstacle information, road information, an attitude signal, a vehicle position and a speed signal; and
the plurality of sensor signals comprise two or more of LIDAR signals, a camera signal, an integrated inertial measurement unit (IMU) signal and a wheel speed signal of the ADV.

8. A method for safety planning, applied in a system for safety planning of an autonomous driving vehicle (ADV) comprising a plurality of sensor signals of the ADV; an autonomous driving domain controller; and a chassis domain controller, the method comprising:
obtaining, by the autonomous driving domain controller, a dynamics safety margin signal by calculating vehicle-related information, wherein the vehicle-related information is obtained by performing fusion calculation based on a plurality of sensor signals;
generating, by the autonomous driving domain controller, a trajectory signal and a wheel speed signal based on the dynamics safety margin signal and a planning decision signal, wherein the planning decision signal is obtained based on the dynamics safety margin signal;
obtaining, by the chassis domain controller, a vehicle estimation and prediction signal by performing calculation based on the plurality of sensor signals and a dynamics control signal of the ADV; and
generating, by the chassis domain controller, a motion control signal by performing coordinated control based on the trajectory signal, the wheel speed signal, and the vehicle estimation and prediction signal, and obtaining, by the chassis domain controller, a control signal for a vehicle-related system by performing control allocation based on the vehicle estimation and prediction signal and the motion control signal.

9. (canceled)

10. A non-transitory computer-readable storage medium having stored a computer program which, when executed by a processor, implements a method for safety planning, the method comprising:
obtaining a dynamics safety margin signal by calculating vehicle-related information, wherein the vehicle-related information is obtained by performing fusion calculation based on a plurality of sensor signals;
generating a trajectory signal and a wheel speed signal based on the dynamics safety margin signal and a planning decision signal, wherein the planning decision signal is obtained based on the dynamics safety margin signal;
obtaining a vehicle estimation and prediction signal by performing calculation based on the plurality of sensor signals and a dynamics control signal of the ADV; and
generating a motion control signal by performing coordinated control based on the trajectory signal, the wheel speed signal, and the vehicle estimation and prediction signal, and obtaining a control signal for a vehicle-related system by performing control allocation based on the vehicle estimation and prediction signal and the motion control signal.

11. (canceled)

12. (canceled)

13. The method according to claim 8, further comprising:
determining, by the chassis domain controller, whether a vehicle-related physical quantity meets a dynamics safety margin constraint condition by verifying the vehicle-related physical quantity based on the dynamics safety margin signal;
activating, by the chassis domain controller, an anti-lock braking system (ABS)/electronic stability control (ESC)/traction control system (TCS) function and sending, by the chassis domain controller, a verification failure signal to the autonomous driving domain controller, in a case that the vehicle-related physical quantity meets the dynamics safety margin constraint condition; and
performing, by the chassis domain controller, dynamics control of the ADV after activating the ABS/ESC/TCS, generating, by the chassis domain controller, a second control signal for the vehicle-related system and send, by the chassis domain controller, the second control signal to the corresponding actuator.

14. The method according to claim 13, further comprising:
obtaining, by the autonomous driving domain controller, a dynamics safety margin signal by calculating the vehicle-related information based on a dynamics model and a tire model of the ADV.

15. The method according to claim 8, further comprising:
obtaining, by the autonomous driving domain controller, a trajectory signal and a wheel speed signal by calculating the planning decision signal and the dynamics safety margin signal, in a case that a current vehicle dynamics state meets a dynamics safety margin constraint condition.

16. The method according to claim 15, further comprising:
estimating, by the autonomous driving domain controller, the current vehicle dynamics state by identifying the vehicle estimation and prediction signal, and
determining, by the autonomous driving domain controller, whether the current vehicle dynamics state meets the dynamics safety margin constraint condition based on the dynamics safety margin signal.

17. The method according to claim 8, wherein
the vehicle-related system comprises a driving system, a braking system, a steering system, and a suspension system of the ADV;
the planning decision signal comprises a lane changing decision signal, a straight driving decision signal, and an obstacle avoidance decision signal;
the dynamics safety margin signal comprises a yaw rate limit and a slip rate limit;
the trajectory signal meets a road margin limit, the yaw rate limit, an acceleration limit, and a lateral acceleration limit;
the wheel speed signal meets the slip rate limit; and
the dynamics control signal comprises feedback signals from the driving system, the braking system, the steering system, and the suspension system.

18. The method according to claim 8, wherein
the vehicle-related information comprises two or more of obstacle information, road information, an attitude signal, a vehicle position and a speed signal; and
the plurality of sensor signals comprise two or more of LIDAR signals, a camera signal, an integrated inertial measurement unit (IMU) signal and a wheel speed signal of the ADV.

19. The storage medium according to claim 10, wherein the method further comprises:
determining whether a vehicle-related physical quantity meets a dynamics safety margin constraint condition by verifying the vehicle-related physical quantity based on the dynamics safety margin signal;
activating an anti-lock braking system (ABS)/electronic stability control (ESC)/traction control system (TCS) function and sending a verification failure signal to the autonomous driving domain controller, in a case that the vehicle-related physical quantity meets the dynamics safety margin constraint condition; and
performing dynamics control of the ADV after activating the ABS/ESC/TCS, generating a second control signal for the vehicle-related system and send the second control signal to the corresponding actuator.

20. The storage medium according to claim 19, wherein the method further comprises:
obtaining a dynamics safety margin signal by calculating the vehicle-related information based on a dynamics model and a tire model of the ADV.

21. The storage medium according to claim 10, wherein the method further comprises:
obtaining a trajectory signal and a wheel speed signal by calculating the planning decision signal and the dynamics safety margin signal, in a case that a current vehicle dynamics state meets a dynamics safety margin constraint condition.

22. The storage medium according to claim 21, wherein the method further comprises:
estimating the current vehicle dynamics state by identifying the vehicle estimation and prediction signal, and
determining whether the current vehicle dynamics state meets the dynamics safety margin constraint condition based on the dynamics safety margin signal.

23. The storage medium according to claim 10, wherein
the vehicle-related system comprises a driving system, a braking system, a steering system, and a suspension system of the ADV;
the planning decision signal comprises a lane changing decision signal, a straight driving decision signal, and an obstacle avoidance decision signal;
the dynamics safety margin signal comprises a yaw rate limit and a slip rate limit;
the trajectory signal meets a road margin limit, the yaw rate limit, an acceleration limit, and a lateral acceleration limit;
the wheel speed signal meets the slip rate limit; and
the dynamics control signal comprises feedback signals from the driving system, the braking system, the steering system, and the suspension system.
